(19) United States
(12) Patent Application Publication
(10) Pub. No.: US 2016/0106265 A1
(43) Pub. Date: Apr. 21, 2016

(54) Spatula Knife Utensil

(71) Applicant: Jackie Holmes, Vineland, NJ (US)

(72) Inventor: Jackie Holmes, Vineland, NJ (US)

(21) Appl. No.: 14/519,586

(22) Filed: Oct. 21, 2014

(51) Int. Cl. A47J 43/28; B26B 11/00

(52) U.S. Cl. CPC A47J 43/288; B26B 11/00; A47J 43/283

(57) ABSTRACT

The disclosed technology comprises a single utensil used for cutting and serving food that has a common handle attached to a knife section and a separate spatula section. Levers and springs are used to separate these sections so that the utensil serves as tongs.

### FIELD OF THE DISCLOSED TECHNOLOGY

The disclosed technology relates to a kitchen utensil and particularly to a spatula and knife combination for easy slicing and serving.

### BACKGROUND OF THE DISCLOSED TECHNOLOGY

Spatulas and knives are well known in the art. However, a convenient way to combine these items for ease of use would be very advantageous. When cutting and serving a particular food item, one first uses a knife to slice the item, and then must find a suitable utensil to serve the food item. Spatulas may be used for certain food items, however, tongs are needed to serve other food items. When using a separate knife and serving utensil, the operator must, not only, find a safe place to put down the knife while the second utensil for serving but must have the second utensil readily available. A convenient utensil that will combine a knife, spatula and tongs would be a very convenient tool for serving food that requires cutting.

### SUMMARY OF THE DISCLOSED TECHNOLOGY

The disclosed technology described herein addresses an unfulfilled need in the prior art by providing a useful and convenient utensil to cut and serve food, especially meat, providing many features not found together in another utensil.

One objective of the disclosed technology is to provide a combination knife spatula utensil comprising a first body with an elongated handle and metal knife blade extended opposite of the handle in a lengthwise direction and a second body with an elongated lever and a flat protrusion spatula section opposite the elongated lever. The spatula section extended in a lengthwise direction and at an angle less than 180 degrees from the elongated lever. The second body movably connected to said first body with means for moving the spatula section and blade in relation to each other from a point where the spatula section and blade are separated to a second point where the blade and spatula section are adjacent.

Another objective is that the means for movably connecting the spatula and blade is pivot and the pivot is at a midpoint of the first body and connected at a midpoint of the second bodies. The pivot moves the first and second body in relation to each other from a point where the lever and handle are adjacent and the knife blade and flat shaped protrusion of the spatula are separated; and to a second point where the handle and lever are separated and the knife blade and flat shaped protrusion of the spatula are adjacent.

In yet another objective, the pivot also has a spring using tension to keep blade and spatula section adjacent unless the lever is pushed towards the handle. Moreover the spring alternatively is a torsion spring between the lever and handle using tension to keep the blade and spatula apart from each other unless the lever is pushed towards the handle. The blade and spatula section end in a matching slant shape.

In another objective a combination knife spatula has a knife body with an elongated handle with sharp metal knife blade extended opposite of the handle in a lengthwise direction. A spatula section adjacent to the knife blade and extended opposite the handle in a lengthwise direction. A lever parallel to the handle and connected to the spatula section with means to move the spatula section away from the knife blade such that the spatula section is moved from a point where the blade and spatula section are adjacent to a second point where the blade and spatula section are apart.

The elongated handle has indentations for fingers of a hand such that the handle has an ergonomic grip and the blade and spatula section end in a matching slant. A spring provides tension to hold the blade and spatula section together. The sping is a torsion spring and a spring end connects the lever and the spatula section such that pressing the lever pulls back on a spring which releases the tension provided by spring and spatula section is separated from the blade.

A second lever is located on an opposite side of the handle and a second spring provides tension to hold the blade and spatula section together and a second spring end connects the second lever and the blade such that pressing the lever pulls back on a spring which releases the tension provided by spring and blade is separated from the spatula section.

In another objective there is a method of using a knife spatula utensil. First, holding a handle of a knife spatula utensil while a spatula section and knife blade are in an adjacent position to each other. Then slicing a food item with a knife blade edge of the knife blade and picking up slices of the food item by squeezing a lever towards the handle and holding handle and lever together thereby separating the knife blade and spatula section.

Next the spatula section is placed under the slices and the lever is released and the knife blade and spatula section are now adjacent to each other and holding the slices of food in between the knife blade and spatula section. The utensil is moved over a plate and serving the slices of food by squeezing the lever thus releasing the slices onto the plate. Alternatively, the food is sliced while the lever is squeezed towards the handle and the knife blade and spatula section are separated.

In a final objective a second method of using a knife spatula utensil is holding a handle and a lever while squeezing them towards each other and a spatula section and knife blade are in an adjacent position to each other. Then slicing a food item with a knife blade edge of the knife blade and picking up slices of the food item by releasing the lever and separating the knife blade from the spatula section.

The spatula section is then placed under slices while squeezing the lever towards the handle. Knife blade and spatula section are now adjacent to each other and holding the slices of food in between the knife blade and spatula section. Then moving utensil over a plate and serving slices of food by releasing the lever and holding only the handle thus releasing the slices onto said plate.

In accordance with these and other objectives, which will become apparent hereinafter, the disclosed technology will now be described with particular reference to the drawings.

### BRIEF DESCRIPTION OF THE DRAWINGS

FIG. 1 shows a perspective view of a first embodiment of the current technology in an open position.

FIG. 2 shows a perspective view of a first embodiment of the current technology in a closed position.

FIG. 3 shows a top view of the first embodiment of the current technology.

FIG. 4 shows a top view of a second embodiment of the current technology.

FIG. 5 shows a perspective view of a third embodiment of the current technology in an open position.

FIG. 6 shows a perspective view of a third embodiment of the current technology in a closed position.

FIG. 7 is a perspective view of the first embodiment of the current technology while being used to slice meat.

FIG. 8 shows a perspective view of a fourth embodiment of the current technology in an open position.

FIG. 9 is a perspective view of the fourth embodiment of the current technology while being used to slice meat.

FIG. 10 is a perspective view of a fifth embodiment of the current technology.

FIG. 11 is a perspective view of a sixth embodiment of the current technology.

A better understanding of the disclosed technology will be obtained from the following detailed description of the preferred embodiments, taken in conjunction with the drawings and the attached claims.

### DETAILED DESCRIPTION OF EMBODIMENTS OF THE DISCLOSED TECHNOLOGY

The ensuing detailed description provides preferred exemplary embodiments only, and is not intended to limit the scope, applicability, or configuration of the disclosed technology. Rather, the ensuing detailed description of the preferred exemplary embodiments will provide those skilled in the art with an enabling description for implementing the preferred exemplary embodiments of the technology. Various changes may be made in the function and arrangement of elements without departing from the spirit and scope of the disclosed technology, as set forth in the appended claims.

To aid in describing the disclosed technology, directional terms may be used in the specification and claims to describe portions of the present technology (e.g., upper, lower, left, right, etc.). These directional definitions are merely intended to assist in describing and claiming the disclosed technology and are not intended to limit the disclosed technology in any way. In addition, reference numerals that are introduced in the specification in association with a drawing figure may be repeated in one or more subsequent figures without additional description in the specification, in order to provide context for other features.

With reference now to the drawings, a device is shown for an apparatus that is a utensil for cutting and serving food and a method is shown for using this new utensil.

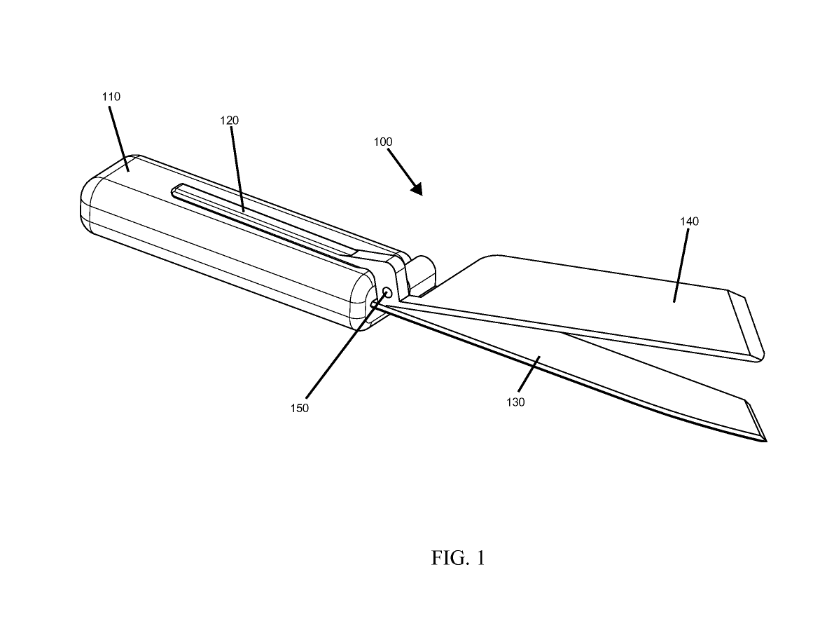

Referring to FIG. 1, reference number 100 refers a knife spatula utensil. The knife spatula utensil of the first embodiment has an elongated handle 110 with sharp metal knife blade 130 extended opposite of the handle 110 in a lengthwise direction creating a first body. A second body having an elongated lever 120 and a flat shaped protrusion or spatula section 140 opposite the lever 120 extended in a lengthwise direction. The lever 120 and spatula section 140 preferably use a pivot 150 as a means of opening and closing the knife spatula utensil 100. In FIG. 1, the lever 120 is pushed toward the handle 110 which raises spatula section 140 away from blade 130.

The knife blade 130 and spatula section 140 can be any length but are preferably is 7.5 inches long from the handle to the tip. Handle 110 is preferably 5 inches long but can be any length between 3 inches to 10 inches. The handle 110 is preferably 0.5 inches deep. The lever 120 is preferably 3 inches long but can be any length from between 1 inch to 10 inches long. The width of the spatula section 140 is any reasonable size but preferably is 3.25 inches wide in the first embodiment. The knife blade 130 can be any reasonable size but in a preferred embodiment the knife blade 130 is preferably 3.635 inches wide with the knife edge 135 below the spatula section by preferably 0.375 inches.

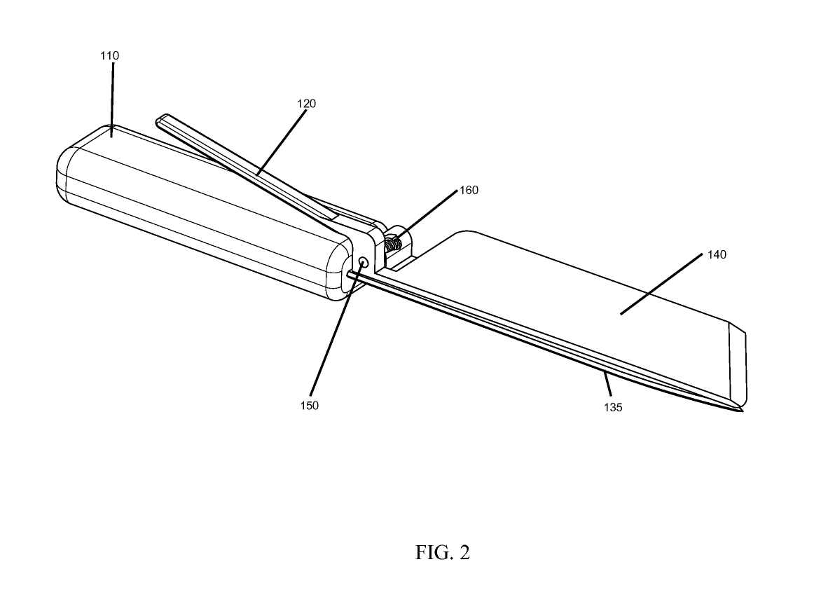

FIG. 2 shows the first embodiment in a closed position, the preferred position for cutting food. The lever 120 is positioned away from the handle 110 and the pivot 150 is in the closed position with the spatula section 140 against the blade 130. Spring such as a torsion spring 160 maintains the utensil 100 in the closed position by pressing open the handle 110 and lever 120,

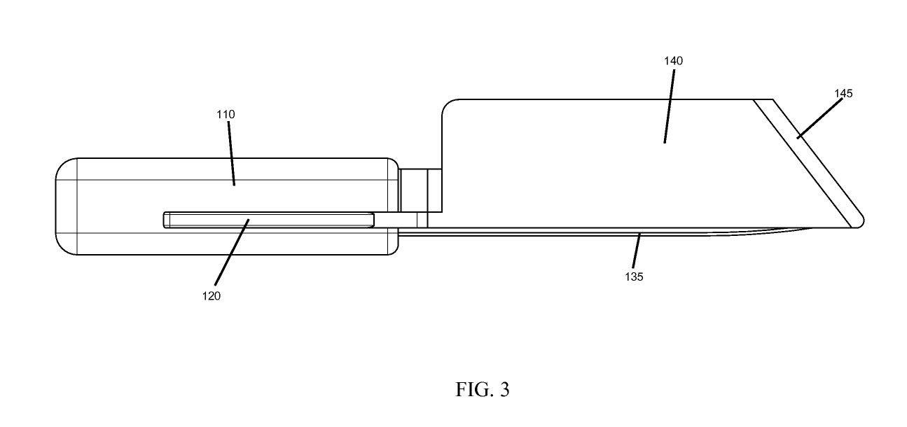

The blade 130 has a sharp edge 135 that is used to cut the food. FIG. 3 shows the edge 135 of the blade 130 positioned lower than the spatula section 140 allowing for the utensil 100 to be used for cutting in the closed position. Alternatively the utensil 100 is used to cut the food while in an open position. The food, once cut, is then served by releasing lever 120 which allows the blade 130 and the spatula section 140 to close around the food, allowing the food to be served.

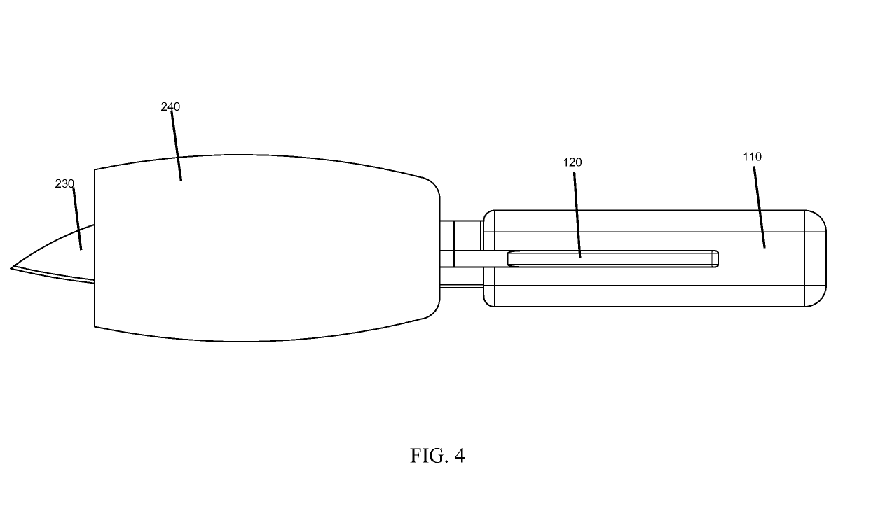

FIG. 3 shows the first embodiment of the current technology shows the spatula section 140 and blade 130 both having a matching slant 145. The matching slant 145 is a preferable configuration of the utensil 100. FIG. 4 shows a second embodiment of the current technology. The lever 120 and handle 110 work in the same fashion as in the first embodiment. The shape and position of the blade 230 has changed. The shape of spatula section 240 has also changed. The blade 230 is situated substantially in the middle of the spatula section 240. For this embodiment the utensil 100 would need to be in an open position with the lever 120 abutting the handle 110 in order to cut food.

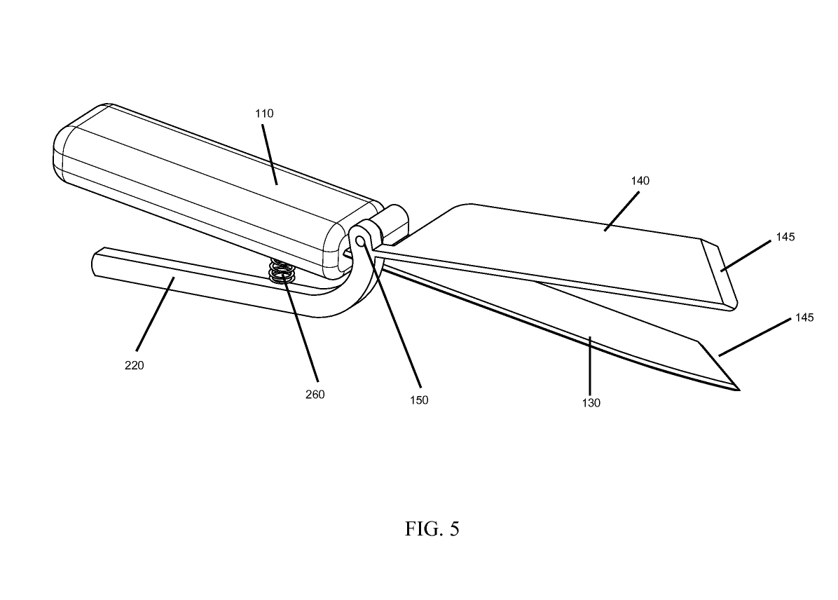

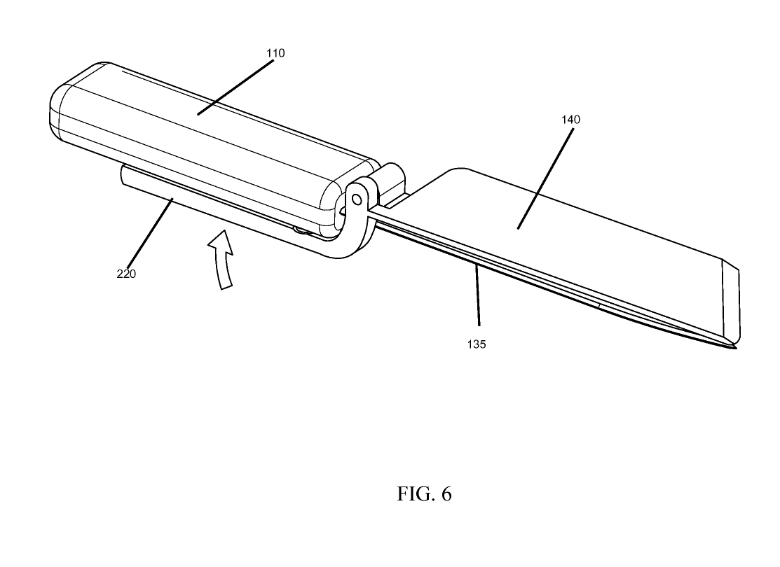

A third embodiment of the current technology is illustrated in FIG. 5. The lever 220 is held at a distance from handle 110 by a spring 260. When the lever 220 is squeezed toward the handle 110, the spring 260 is compressed. The utensil 100 preferably cuts food in the closed position with the spatula section 140 positioned adjacent to blade 130. FIG. 6 shows this third embodiment in the closed position. The food, once cut, is then served by releasing lever 120 which allows the blade 130 and the spatula section 140 to close around the food, allowing the food to be served. Alternatively, in the closed position the utensil 100 is also used as a conventional spatula

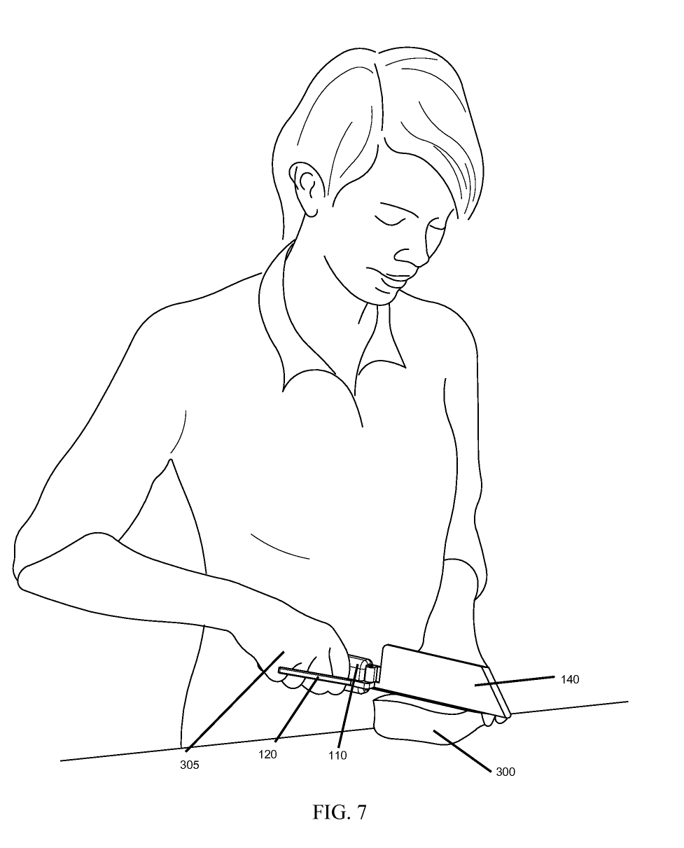

Now referring to FIG. 7, the first embodiment of the current technology is show being used to cut a piece of meat 300. A hand 305 is shown holding the handle 110 but not pressing the lever 120. The edge 135 of the blade 130 cuts through the meat 300.

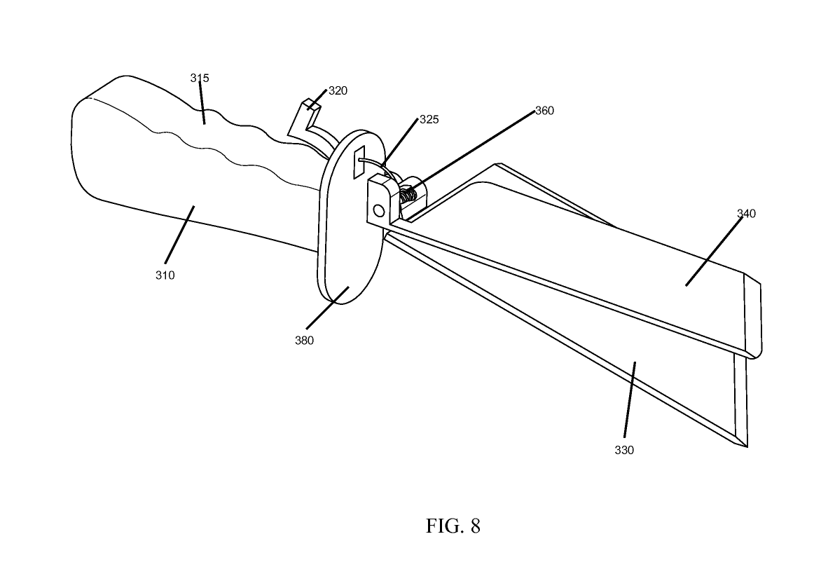

FIG. 8 illustrates a fourth embodiment of the current technology. Spatula section 340 and blade 330 are held together by the tension of spring 360. Handle 310 now has a platform 380. Handle 310 is also has indentations 315 to form a contour that provides comfort for the fingers of a hand. Pressing lever 320 pulls back an end of a torsion spring 325 that releases the tension provided by spring 360 such that spatula section 340 is separated from blade 330.

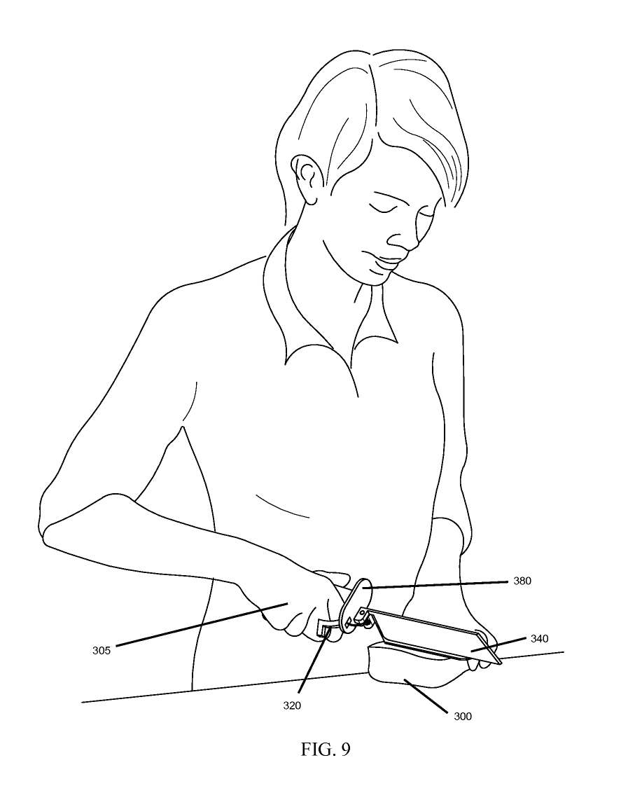

The fourth embodiment of the current technology is used for cutting meat 300 in FIG. 9. A hand 305 is shown holding the handle 310 but not pressing the lever 320. Blade 330 edge 335 cuts through the meat 300.

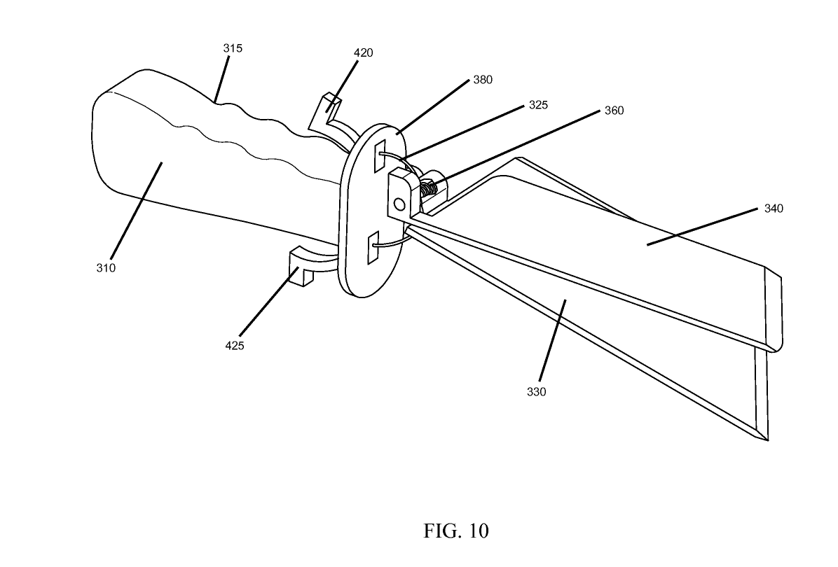

Moving to FIG. 10, a fifth embodiment of the utensil 100 is shown. In this embodiment, levers 420 and 425 move both the blade 330 and the spatula section 340, respectively. The lever 420 opens the utensil 100 by moving spatula section 340 away from the blade 330. Also the lever 425 opens the utensil 100 by moving the blade 330 away from the spatula section 340.

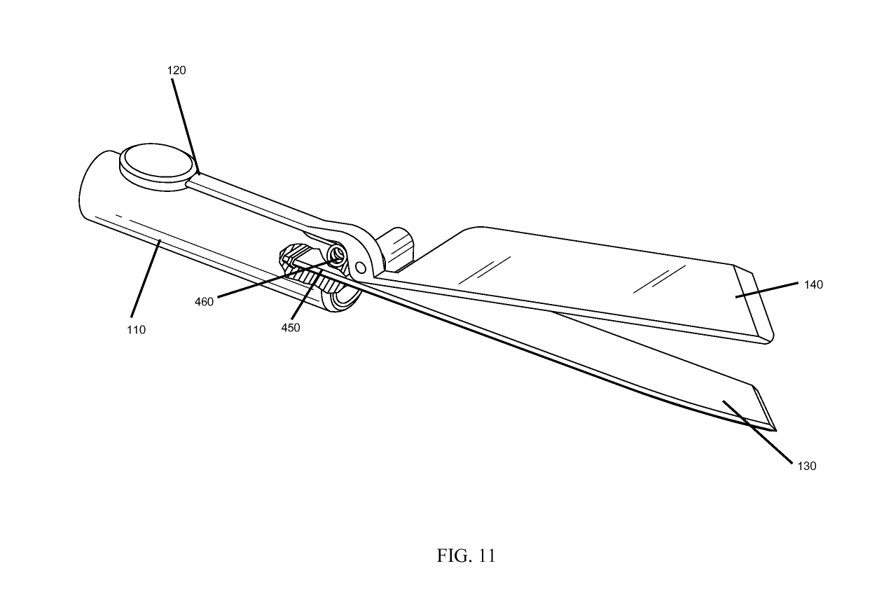

FIG. 11 illustrates a sixth embodiment of the utensil 100. Spatula section 140 and blade 130 are held together by the tension of spring 460. Handle 110 when squeezed towards lever 120 pulls back an end of a torsion spring 460 that releases the tension provided by spring 460 such that spatula section 140 is separated from blade 130. Spatula section 140 and blade 130 also have a narrowed base 450 that is formed in the handle 110.

A method of using a knife spatula utensil. In a first method a person will hold only the handle 110 of FIG. 1 but not press the lever 120. Metal knife blade 130 and spatula section 140 will stay in an adjacent position to each other, while knife blade edge 135 is used to cut through meat 300 or any other food item. After the meat 300 or food item is sliced, knife spatula utensil 100 is then used to pick up and serve the slices. Handle 110 and lever 120 are held together by hand 305 and spatula section 140 goes under the slice or slices of food. Then lever 120 is let go, which again bring blade 130 and spatula section 140 adjacent to each other now holding the meat 300 or food slices in between the knife blade 130 and spatula section 140. Thus, the slices can be moved to a plate. Once slices are at the plate, lever 120 is moved towards handle 110 to separate blade 130 from spatula section 140 thus releasing the slices onto said plate.

A second method of using the knife spatula utensil is that the meat 300 or food can be sliced while the blade 130 and spatula section 140 are apart. The blade section 130 would have to be between the edge of the meat 300 or food and the spatula section 140 for this to work. The lever 120 is held next to handle 110 while the meat 300 or food is sliced. After the meat 300 or food is sliced, and while still holding lever 120 next to handle 110, slices of meat 300 or food are picked up by the spatula section 140. Lever 120 is let go which again bring blade 130 and spatula section 140 adjacent to each other, and that holds the meat 300 slices or food slices in between the knife blade 130 and spatula section 140. Slices are now moved to a plate. Once slices are at the plate, lever 120 is moved towards handle 110 to release the slices onto said plate.

A third alternative method of using the knife spatula utensil 100 is to use the embodiment of the knife spatula utensil used in FIG. 5 to cut and serve food. Lever 220 is held next to handle 110 and keeps the blade 130 adjacent to spatula section 140 while the knife spatula utensil 100 cuts into the meat 300 or other food. The knife blade 130 and spatula section 140 are then separated by letting handle 110 and lever 220 separate. Spatula section 140 is then placed under meat 300 or food. Lever 220 is then held next to handle 110 which again brings blade 130 and spatula section 140 adjacent to each other, but this time holding the meat 300 slices or food in between the knife blade 130 and spatula section 140. Meat 300 or food slices are moved to a plate and once slices are at the plate, lever 220 is moved away handle 110 to release the slices of food or meat 300 onto said plate.

A forth method of using the knife spatula utensil 100 is still using the utensil 100 as seen in FIG. 5 but cutting the food or meat 300 while blade 130 and spatula section 140 are apart and the hand holding only handle 110. While spatula section 140 and blade 130 are still apart, spatula section 140 is placed under meat 300 or food slices. Lever 220 is then held next to handle 120 which again bring blade 130 and spatula section 140 adjacent, which holds the meat 300 or food slices in between the knife blade 130 and spatula section 140. Once slices of food or meat 300 are at the plate, lever 220 is moved away handle 110 to release the slices onto said plate.

It is recognized by those skilled in the art that changes may be made to the above described embodiments of the disclosed technology without departing from the broad inventive concept thereof. It is understood, therefore, that this technology is not limited to the particular embodiments disclosed but is intended to cover all modifications which are in the spirit and scope of the disclosed technology.

I claim:

1. A combination knife spatula utensil comprising;
a first body with an elongated handle and metal knife blade extended opposite of the handle in a lengthwise direction;
a second body with an elongated lever and a flat protrusion spatula section opposite the elongated lever;
spatula section extended in a length wise direction and at an angle less than 180 degrees from the elongated lever;
said second body movably connected to said first body;
and means for moving the spatula section and blade in relation to each other from a point where the spatula section and blade are separated to a second point where the blade and spatula section are adjacent.

2. The utensil of claim 1 wherein means for movably connecting the spatula and blade is pivot and said pivot is at a midpoint of the first body and connected at a midpoint of the second bodies; the pivot moves the first and second body in relation to each other from a point where the lever and handle are adjacent and the knife blade and flat shaped protrusion of the spatula are separated; and to a second point where the handle and lever are separated and the knife blade and flat shaped protrusion of the spatula are adjacent.

3. The utensil of claim 2, wherein pivot also has a spring using tension to keep blade and spatula section adjacent unless the lever is pushed towards the handle.

4. The utensil of claim 2, wherein a spring is between the lever and handle is a torsion spring using tension to keep the blade and spatula apart from each other unless the lever is pushed towards the handle.

5. The utensil of claim 1, wherein the blade and spatula section end in a matching slant shape.

6. The utensil of claim 1, wherein the flat protrusion spatula further comprising a narrow base between the spatula and elongated lever, inserted and connected to the elongated handle.

7. A utensil comprising;
a combination knife spatula having a knife body with an elongated handle with sharp metal knife blade extended opposite of the handle in a lengthwise direction;
a spatula section adjacent to the knife blade and extended opposite the handle in a lengthwise direction;
a lever parallel to the handle and connected to the spatula section with means to move the spatula section away from the knife blade such that the spatula section is moved from a point where the blade and spatula section are adjacent to a second point where the blade and spatula section are apart.

8. The utensil of claim 7, wherein the elongated handle has indentations for fingers of a hand such that the handle has an ergonomic grip.

9. The utensil of claim 7, wherein the blade and spatula section end in a matching slant counter.

10. The utensil of claim 7, wherein a spring provides tension to hold the blade and spatula section together and a spring end connects the lever and the spatula section such that pressing the lever pulls back on a spring which releases the tension provided by spring and spatula section is separated from the blade.

11. The utensil of claim 10, wherein a second lever is located on an opposite side of the handle and a second spring provides tension to hold the blade and spatula section together and a second spring end connects the second lever and the blade such that pressing the lever pulls back on a spring which releases the tension provided by spring and blade is separated from the spatula section.

12. The method of using a knife spatula utensil:
holding a handle of a knife spatula utensil while a spatula section and knife blade are in an adjacent position to each other;
slicing a food item with a knife blade edge of the knife blade;
picking up slices of the food item by squeezing a lever towards the handle and holding handle and lever together thereby separating the knife blade and spatula section;
placing spatula section under the slices and releasing the lever, knife blade and spatula section are now adjacent to each other and holding the slices of food in between the knife blade and spatula section;
moving utensil over a plate and serving slices of food by squeezing the lever thus releasing the slices onto said plate.

13. The method of claim 12, wherein the food is sliced while the lever is squeezed towards the handle and the knife blade and spatula section are separated.

14. The method of using a knife spatula utensil:
holding a handle and a lever while squeezing them towards each other and a spatula section and knife blade are in an adjacent position to each other;
slicing a food item with a knife blade edge of the knife blade;
picking up slices of the food item by releasing the lever and separating the knife blade from the spatula section;
placing spatula section under slices and then squeezing the lever, knife blade and spatula section are now adjacent to each other and holding the slices of food in between the knife blade and spatula section;
moving utensil over a plate and serving slices of food by releasing the lever and holding only the handle thus releasing the slices onto said plate.
